(19) United States
(12) Patent Application Publication
(10) Pub. No.: US 2011/0158401 A1
(43) Pub. Date: Jun. 30, 2011

(54) SYSTEM AND METHOD FOR SIGNING ELECTRONIC DOCUMENT

(75) Inventors: CHUNG-I LEE, Tu-Cheng (TW); HAI-HONG LIN, Shenzhen City (CN); GANG XIONG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/911,741

(22) Filed: Oct. 26, 2010

(30) Foreign Application Priority Data
Dec. 31, 2009 (CN) 200910312945.6

(51) Int. Cl. H04L 9/30; H04L 9/32

(52) U.S. Cl. 380/30; 713/176

(57) ABSTRACT

A method for signing an electronic document includes receiving a digital signature request of an electronic document from a client computer, the digital signature request comprising the electronic document and an identifier of the electronic document, sending the electronic document to a corresponding application server determined by the identifier of the electronic device. The method further includes receiving a signed value from the client computer, sending the signed value to the corresponding application server to generate a digitally-singed electronic document by merging the signed value and the electronic document.

### BACKGROUND

1. Technical Field

Embodiments of the present disclosure relate to signature technology, and particularly to a system and method for signing an electronic document.

2. Description of Related Art

“Signature” is a very important work in an enterprise. Many documents (such as contracts or orders) need to be signed by a leader. For example, a purchase order will not to be performed if the purchase order is not authorized and signed by the leader. However, currently, a single application server is used to process signatures on electronic documents. If many electronic documents need to be signed, the single application server would spend much time to sign the electronic documents. Thus, it is time-consuming and inefficiently to process signatures on multiple electronic documents.

### BRIEF DESCRIPTION OF THE DRAWINGS

FIG. 1 is a system view of one embodiment of an entry server in communication with a plurality of client computers and a plurality of application servers.

FIG. 2 is a block diagram of one embodiment of a client computer, an entry server and an application server in FIG. 1.

FIG. 3 is a flowchart of one embodiment of a method for signing an electronic document.

### DETAILED DESCRIPTION

All of the processes described below may be embodied in, and fully automated by, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

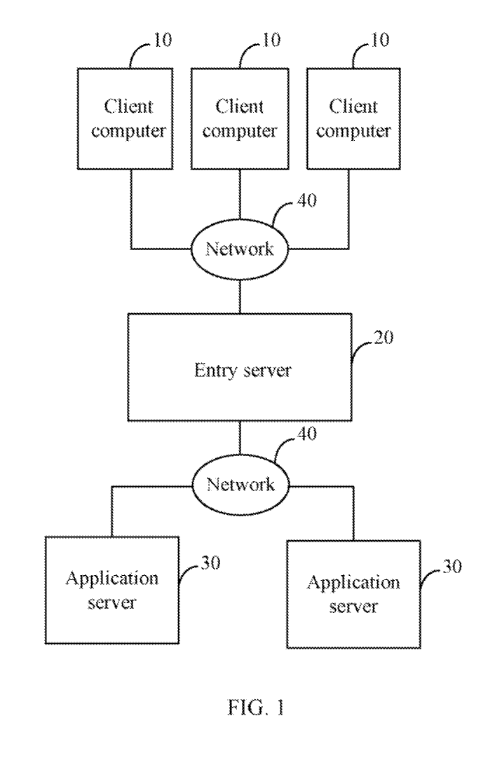

FIG. 1 is a system view of one embodiment of an entry server 20 in communication with a plurality of client computers 10 and a plurality of application servers 30. In some embodiments, the entry server 20 allocates electronic documents to corresponding application servers 30. Detailed descriptions will be given in the following paragraphs.

In some embodiments, each of the client computers 10 electronically connects to the entry server 20 through a network 40. Each of the application server 30 electronically connects to the entry server 20 through the network 40. The client computer 10 stores electronic documents to be signed and a corresponding identifier. The client computer 10 further stores a digital certificate of a signer, the digital certificates are issued by an authorized third-party organization. In some embodiments, the digital certificate may include, but are not limited to, a public key, a private key, or signer information, for example. The public key is used to verify the identity of the signer when the signer receives the digital signature. The private key is kept secret and is used for the digital signature. The network 40 may be an intranet, the Internet or other suitable communication networks. The entry server 20 and the application servers 30 may be computers, or other suitable computing devices. Each of the application servers 30 has a corresponding serial number, such as “1,” “2,” “3,” “4,” and “5.”

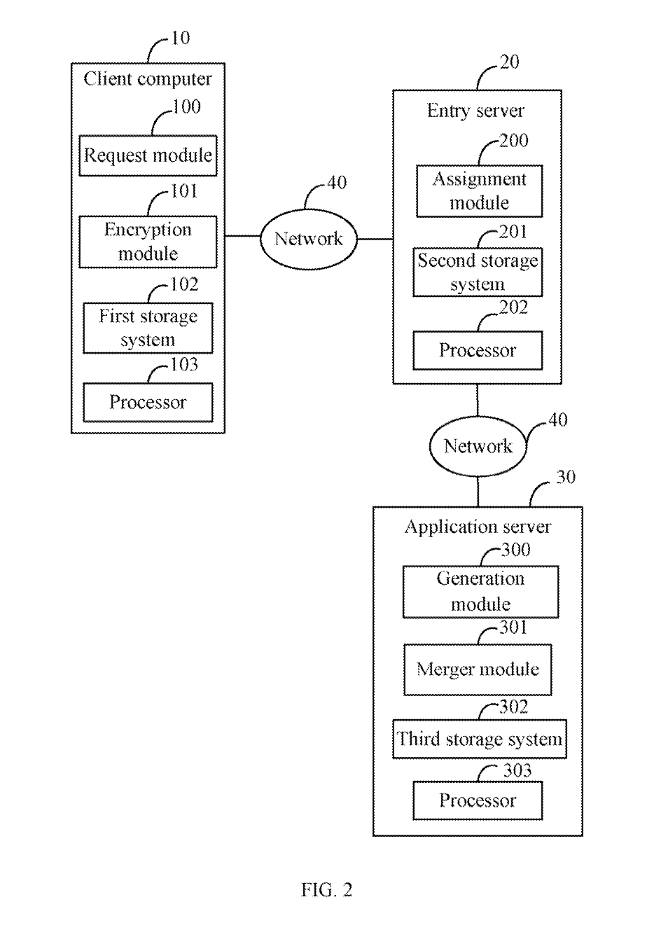

FIG. 2 is a block diagram of one embodiment of the client computer 10, the entry server 20, and the application server in FIG. 1. The client computer 10 includes a request module 100, an encryption module 101, a first storage system 102, and a processor 103. In some embodiments, the modules 100 and 101 may comprise computerized code in the form of one or more programs that are stored in the first storage system 102 (or memory). The computerized code includes instructions that are executed by the at least one processor 103 to provide functions for modules 100 and 101.

The entry server 20 includes an assignment module 200, a storage system 201, and a processor 202. In some embodiments, the module 200 may comprise computerized code in the form of one or more programs that are stored in the second storage system 201 (or memory). The computerized code includes instructions that are executed by the at least one processor 202 to provide functions for modules 200.

The application server 30 includes a generation module 300, a merger module 301, a third storage system 302, and a processor 303. In some embodiments, the modules 300 and 301 may comprise computerized code in the form of one or more programs that are stored in the third storage system 302 (or memory). The computerized code includes instructions that are executed by the at least one processor 303 to provide functions for modules 300 and 301.

The request module 100 sends a digital signature request of an electronic document in the first storage system 102 to the entry server 20. In some embodiments, the digital signature request may include the electronic document and the corresponding identifier of the electronic document.

The assignment module 200 calculates an assignment value of the electronic document, and sends the electronic document to a corresponding application server 30 according to the assignment value. Firstly, the assignment module 200 calculates a hash value of the identifier of the electronic document according to a hash algorithm. The hash algorithm transforms the electronic document into a fixed-length character string, to shorten the length of the digital signature. The fixed-length character string may be 128 bit, 160 bit, 256 bit, and 512 bit. Secondly, the assignment module 200 obtains a total number of the application servers 30 from the second storage system 201. The assignment value can be calculated according to the hash value of the identifier of the electronic documents and the total number of the application servers 30 using a complementation algorithm by the assignment module 200. Finally, the assignment module 200 sends the electronic document to the application server 30 according to the assignment value.

For example, the hash value of the identifier of the electronic document is “100,” and the total number of the application servers 30 is “8.” The assignment module 200 calculates the assignment value “4” according to “100” and “8” using the complementation algorithm. In this particular example, 100 divide by 8=A, and has a remainder (i.e., the assignment value) of 4. The assignment module 200 sends the electronic document to the application server 30 having a serial number of “4.”

Upon receiving the electronic document from the entry server 20, the generation module 300 generates a hash value of the electronic document according to the hash algorithm, and sends the hash value of the electronic document to the client computer 10. The hash value of the electronic document is a numerical representation of content of the electronic document according to the hash algorithm. In some embodiments, the hash algorithm may be a secure hash algorithm 1 (SHA1).

Upon receiving the hash value of the electronic document from the application server 30, the encryption module 101 encrypts the hash value of the electronic document to generate a signed value, and sends the signed value to the entry server 20. In some embodiments, the encryption module 101 encrypts the hash value of the electronic document with the private key using a public key cryptogram algorithm to generate the signed value. For example, the public key cryptogram algorithm may be Ron Rivest, Adi Shamir, and Len Adleman (RSA). The public key cryptogram algorithm is also known as an asymmetry algorithm to encrypt and decrypt electronic documents with different keys (the public key and the private key).

Upon receiving the signed value from the client computer 10, the assignment module 200 sends the signed value to the application server 30 determined by the assignment value. For example, if the assignment value is “4,” the assignment module 200 sends the electronic document to the application server 30 having the serial number of “4.”

In some embodiments, upon receiving the signed value from the entry server 20, the merger module 301 merges the signed value and the electronic document according to a Cryptographic Message Syntax Standard (e.g., PKCS#7) to generate a digitally-signed electronic document. The PKCS refers to a group of Public Key Cryptography Standards.

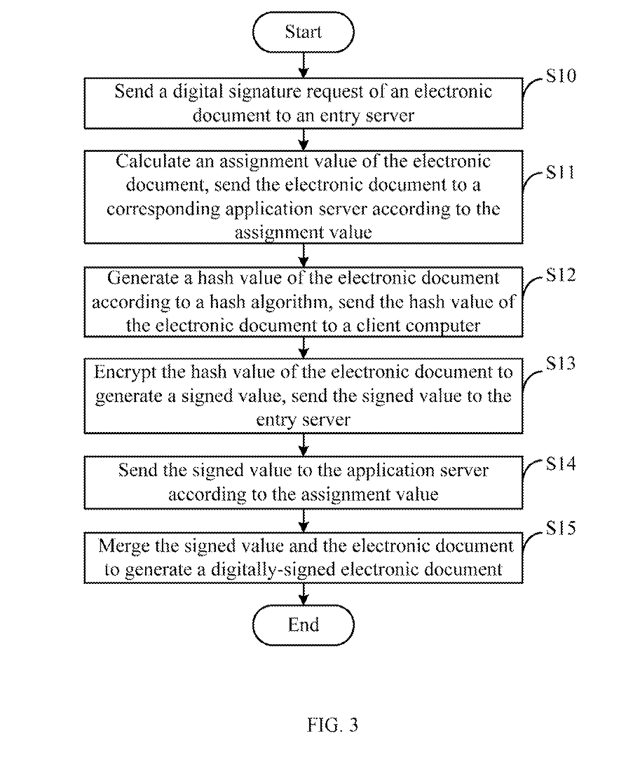

FIG. 3 is a flowchart of one embodiment of a method for signing an electronic document. Depending on the embodiment, additional blocks may be added, others removed, and the ordering of the blocks may be changed.

In block S10, the request module 100 of the client computer 10 sends a digital signature request of an electronic document in the first storage system 102 to the entry server 20. The digital signature request may include the electronic document and an identifier of the electronic document.

In block S11, the assignment module 200 of the entry server 20 calculates an assignment value of the electronic document, and sends the electronic document to a corresponding application server 30 according to the assignment value.

In block S12, the generation module 300 of the application server 30 generates a hash value of the electronic document according to the hash algorithm, and sends the hash value of the electronic document to the client computer 10.

In block S13, the encryption module 101 of the client computer 10 encrypts the hash value of the electronic document to generate a signed value, and sends the signed value to the entry server 20. The encryption module 101 encrypts the hash value of the electronic document with the private key using a public key cryptogram algorithm such as a RSA algorithm to generate the signed value.

In block S14, the assignment 200 of the entry server 20 sends the signed value to the application server 30 corresponding to the assignment value.

In block S15, the merger module 301 of the application server 30 merges the signed value and the electronic document according to a PKCS#7 to generate a digitally-signed electronic document.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of signing an electronic document, the method comprising:
receiving a digital signature request of an electronic document from a client computer, the digital signature request comprising the electronic document and an identifier of the electronic document;
sending the electronic document to a corresponding application server determined by the identifier of the electronic device;
receiving a signed value from the client computer; and
sending the signed value to the corresponding application server to generate a digitally-singed electronic document by merging the signed value and the electronic document.

2. The method according to claim 1, wherein the signed value is generated by encrypting a hash value of the electronic document, the hash value of the electronic document is a numerical representation of the content of the electronic document according to the hash algorithm.

3. The method according to claim 2, wherein the hash algorithm is a secure hash algorithm 1 (SHA1).

4. The method according to claim 1, wherein the signed value is encrypted by a public key cryptogram algorithm.

5. The method according to claim 1, wherein the digitally-signed electronic document is generated by merging the signed value and the electronic document according to a group of public key cryptography standards (PKCS).

6. A storage medium having stored thereon instructions that, when executed by a processor, cause the processor to perform a method for signing an electronic document, the method comprising:
receiving a digital signature request of an electronic document from a client computer, the digital signature request comprising the electronic document and an identifier of the electronic document;
sending the electronic document to a corresponding application server determined by the identifier of the electronic device;
receiving a signed value from the client computer; and
sending the signed value to the corresponding application server to generate a digitally-singed electronic document by merging the signed value and the electronic document.

7. The medium according to claim 6, wherein the signed value is generated by encrypting a hash value of the electronic document, the hash value of the electronic document is a unique and extremely compact numerical representation of the content of the electronic document according to the hash algorithm.

8. The medium according to claim 7, wherein the hash algorithm is a secure hash algorithm 1 (SHA1).

9. The medium according to claim 6, wherein the signed value is encrypted by a public key cryptogram algorithm.

10. The medium according to claim 6, wherein the digitally-signed electronic document is generated by merging the signed value and the electronic document according to a group of public key cryptography standards (PKCS).

11. An electronic device for signing an electronic document, the electronic device comprising:
a storage system;
at least one processor; and
one or more programs stored in the storage system and being executable by the at least one processor, the one or more programs comprising:
an assignment module operable to send the electronic document to a corresponding application server determined by an identifier of the electronic device, and to send a signed value to the corresponding application server to generate a digitally-singed electronic document by merging the signed value and the electronic document.

12. The electronic device according to claim 11, wherein the signed value is generated by encrypting a hash value of the electronic document, the hash value of the electronic document is a numerical representation of content of the electronic document according to the hash algorithm.

13. The electronic device according to claim 12, wherein the hash algorithm is a secure hash algorithm 1 (SHA1)

14. The electronic device according to claim 11, wherein the signed value is encrypted by a public key cryptogram algorithm.

15. The electronic device according to claim 11, wherein the digitally-signed electronic document is generated by merging the signed value and the electronic document according to a group of public key cryptography standards (PKCS).
